(19) United States
(12) Patent Application Publication
(10) Pub. No.: US 2005/0202373 A1
(43) Pub. Date: Sep. 15, 2005

(54) Novel surgical blade for finishing composite fillings on the mesial surface of molars and premolars and method of use

(76) Inventors: Penny Peng, Hacienda Heights, CA (US); Kenton B. Abel, Hacienda Heights, CA (US)

Correspondence Address: Penny Peng, 3147 Cabo Blanco Dr., Hacienda Heights, CA, 91745, US

(21) Appl. No.: 11/078,718

(22) Filed: Mar. 11, 2005

Related U.S. Application Data
(60) Provisional application No. 60/552,817, filed on Mar. 13, 2004.

(51) Int. Cl. A61C 5/04; A61C 3/02

(52) U.S. Cl. 433/226; 433/144

(57) ABSTRACT

A method for finishing class II composite fillings on a mesial surface of molar and premolar teeth comprising using a blade to scrape excess resin on the mesial surface a molar or premolar tooth, wherein the blade comprises a blade protrusion on one side and the blade protrusion comprises a cutting edge, and the cutting edge is curved to compliment the mesial curvature of a molar or premolar tooth.

This application claims benefit under 35 U.S.C. §119(e) to U.S. Ser. No. 60/552,817, filed Mar. 13, 2004, expressly incorporated by reference in its entirety.

### FIELD OF THE INVENTION

The field of the invention pertains to a method and apparatus for finishing composite fillings on mesial surface of molars and premolars. More particularly, the field of this invention pertains to removing excess composite material used in Class II fillings.

### BACKGROUND OF THE INVENTION

The field of the invention pertains to a method and apparatus for finishing composite fillings on mesial surface of molars and premolars. More particularly, the field of this invention pertains to removing excess composite material used in Class II fillings.

In the prior art, a number 12 surgical blade is commonly used to finish composite fillings on all teeth. This blade works well on distal surfaces of all teeth and can be used relatively easily on the mesial surface of teeth numbers 5-12 and 21-28. However, because of the anatomy of the mouth, the number 12 surgical blade does not work well to finish composite fillings on the mesial surface of teeth 1-4, 13-20 and 29-32.

To address the inherent problem of finishing composite material on the fillings on the mesial surface of the molars and premolars, some practitioners use a finishing bur on a high-speed handpiece, or sand paper finishing strips, or the off-angle gold knifes.

These prior art devices suffer from disadvantages, which make them undesirable to use. For example, with a high-speed handpiece, it is difficult to have steady control while in operation and there is a limitation on access due to interference by the cheek and tongue. A primary disadvantage of sand paper finishing strips is that the tight contacts between teeth disallowed the finishing strips to slide through interproximal area. The off-angle gold knifes are too bulky to work interproximally, too dull to finish composite fillings, and not curved to approximate the molar or premolar tooth surface.

In view of the foregoing, there is a demand for an apparatus and a method for finishing composite fillings on the mesial surface of molars and premolars.

### SUMMARY OF THE PREFERRED EMBODIMENTS

One aspect of the current invention provides a blade with the cutting surface curved in a reverse crescent shape to match the mesial surfaces of the molars and premolars.

Another aspect of the present invention provides a disposable blade with a cutting surface curved in a reverse crescent shape to match the mesial surfaces of the molars and premolars.

An aspect of the method of the current invention provides finishing a composite filling on the mesial surfaces of the molars and premolars by using a blade with the cutting surface curved in a reverse crescent shape to match the mesial surfaces of the molars and premolars.

### BRIEF DESCRIPTION OF THE FIGURES

FIG. 1 is a schematic view of adult teeth showing the maxillary numbering of 1-16 and the mandibular numbering of 17-32.

FIG. 2 is a perspective view of a human mouth showing the cheek obstructs access to the molars and premolars.

FIG. 3 is a schematic view of the maxillary teeth.

FIG. 4 is a perspective view of a human mouth showing how the cheek obstructs access to the molars and premolars. FIG. 4 also shows use of a handpiece on the maxillary teeth.

FIG. 5 is a perspective view of a human mouth showing how the cheek and tongue obstruct access to the lingual side of the molars and premolars. FIG. 5 also shows use of a handpiece on the mandibular teeth.

FIG. 6 is a schematic view of various disposable surgical blades currently available. The number below the blades is the surgical blade number.

FIG. 7A is a schematic view of one side a surgical blade of the current invention. FIG. 7B is a schematic view of the opposite side of a surgical blade of the current invention.

FIG. 8 is a schematic view of a surgical blade of the current invention attached to a handle.

FIG. 9 is a schematic view of a number 12 surgical blade attached to a handle.

FIG. 10A is an outline view of a first side a surgical blade of the current invention attached to a handle. FIG. 10B is an outline view of a second side a surgical blade of the current invention attached to a handle. FIG. 10C is an outline view of one side a number 12 surgical blade attached to a handle.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided as illustrations so that this disclosure will be thorough and complete, and will fully convey the scope of the invention to those skilled in the art.

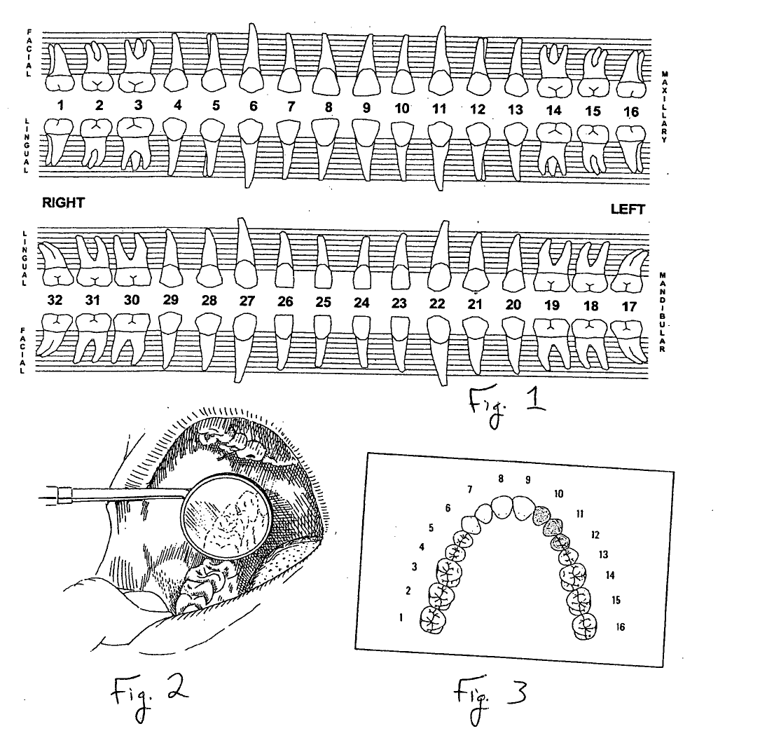

In reference to FIG. 1, the molars and premolars are teeth numbers 1-5, 12-21 and 28-32. The mesial surfaces are understood to include both the facial and lingual sides of the teeth.

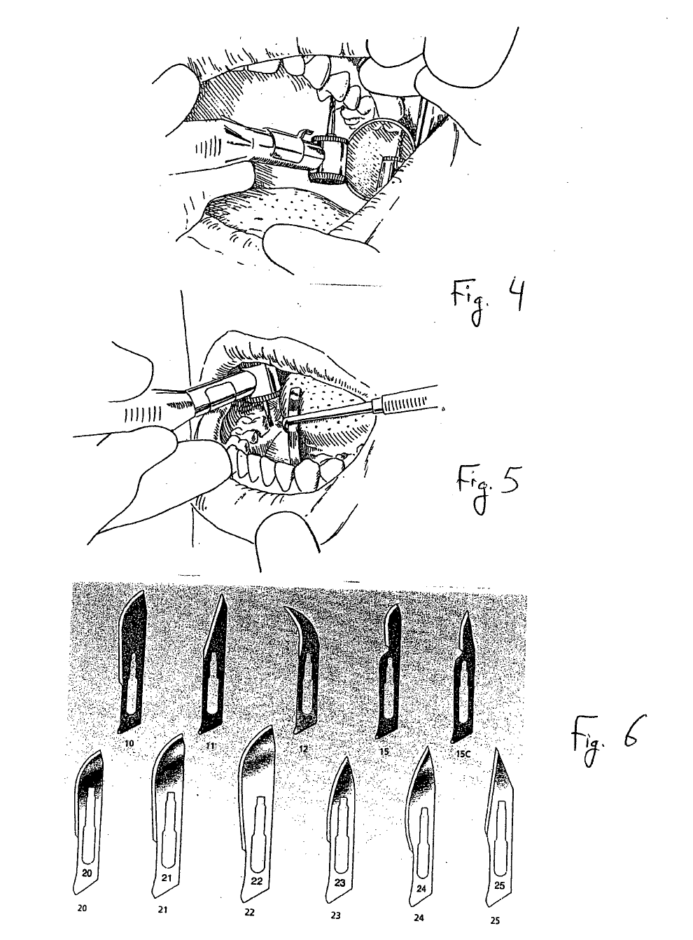

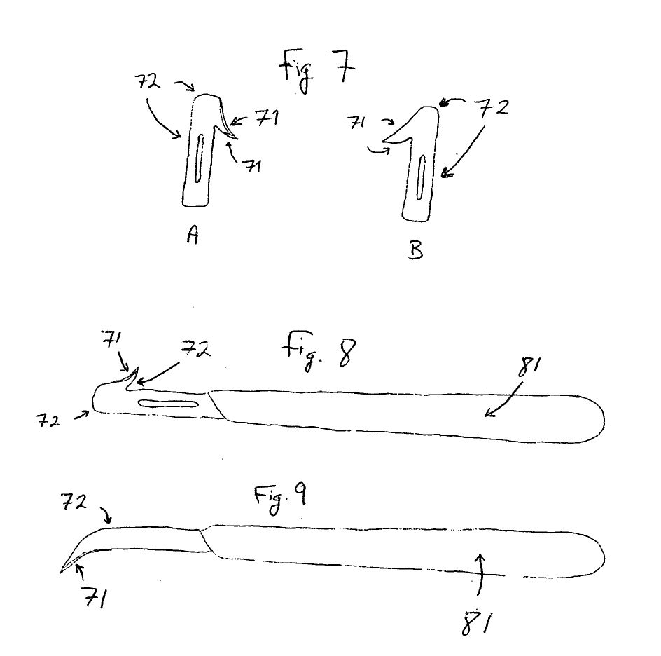

In reference to FIGS. 2-6, various prior art methods and/or apparatus. These will be well understood to those of skill in the art.

In reference to FIG. 7, a cutting edge 71 is on one side of a blade protrusion 73 and has a curvature to approximately match the curvature of the mesial surface of a molar or premolar tooth. A non-cutting edge 72 prevents accidental cutting of soft tissue. In a preferred embodiment, the non-cutting edge 72 is smoothed to eliminate rough edges.

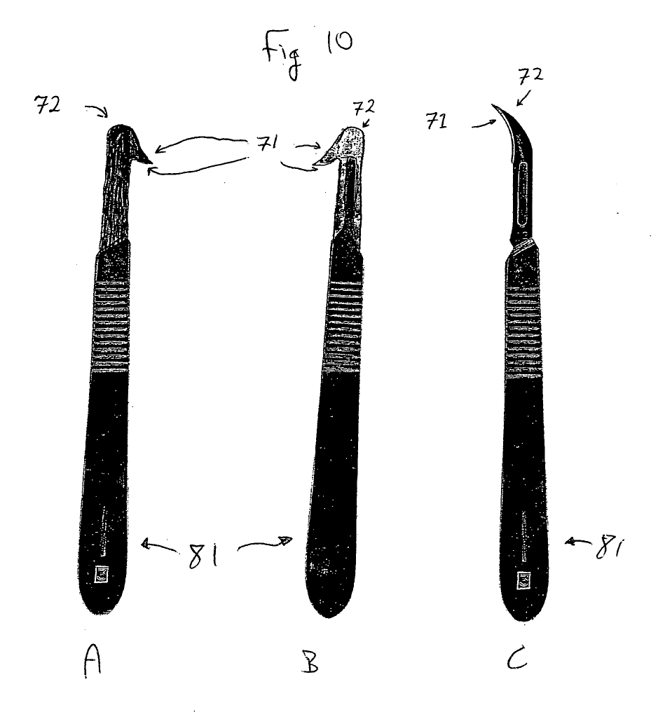

In reference to FIG. 8, the blade of the present invention is coupled with a handle 81. As seen in this figure, the cutting edge 71 is on the distal side of the blade protrusion 73 relative to the handle 81. The curvature of the cutting edge 71 compliments the mesial surface of a molar or premolar tooth.

While one of skill in the art will understand how to use the blade of the present invention to finish class II resin filings and resin cement on the mesial surfaces of the molars and premolars, a brief explanation is given here for completeness. A dental professional can use the blade of the present invention by aligning the cutting edge 71 with the mesial surface of a tooth just below the tooth contact area in need of finishing. The dental professional will apply a slight force against the tooth surface and scrap the blade protrusion 73 away from the patient's gum line.

In reference to FIG. 9, a prior art “number 12” blade is attached to a handle 81. In contrast to the blade of the present invention, the motion used with a number 12 blade to remove excess composite filling on the distal surfaces of the molars and premolars, the practitioner will use a pulling motion towards the coronal surface of the tooth.

It is to be understood that the curved shape that approximates the mesial surfaces of the molars and premolars can be applied to periodontal scaler instruments and other dental instruments.

Whereas particular embodiments of the invention have been described above for purposes of illustration, it will be appreciated by those skilled in the art that numerous variations of the details may be made without departing from the invention as described in the appended claims.

1. A method for finishing class II composite fillings on a mesial surface of molar and premolar teeth comprising:
using a blade to scrape excess resin on the mesial surface a molar or premolar tooth,
wherein the blade comprises a blade protrusion on one side,
wherein the protrusion comprises a cutting edge,
wherein the cutting edge is curved to compliment the mesial curvature of a molar or premolar tooth on the distal portion of the blade protrusion relative to the handle.

2. The method of claim 1, wherein the blade is disposable.

3. The method of claim 1, wherein the handle is disposable.

4. The method of claim 1, wherein the blade sufficiently thin to fit between the tooth in need of finishing and the adjacent tooth.

5. The method of claim 1, wherein the handle is curved greater than 5 degrees at a location near the blade.

6. The method of claim 5, wherein the handle is curved greater than 5 degrees in a vertical direction relative to the flat surface of the blade.

7. The method of claim 5, wherein the handle is curved greater than 5 degrees in a horizontal direction relative to the flat surface of the blade.
